(19) United States
(12) Patent Application Publication
(10) Pub. No.: US 2005/0217500 A1
(43) Pub. Date: Oct. 6, 2005

(54) Multi-use rack

(75) Inventor: Wesley Owens Dunn, Mount Juliet, TN (US)

Correspondence Address: PEARNE & GORDON LLP, 1801 EAST 9TH STREET, SUITE 1200, CLEVELAND, OH, 44114-3108, US

(73) Assignee: Electrolux Home Products, Inc., Cleveland, OH (US)

(21) Appl. No.: 11/085,737

(22) Filed: Mar. 21, 2005

Related U.S. Application Data
(60) Provisional application No. 60/558,273, filed on Mar. 31, 2004.

(51) Int. Cl. A47J 43/18

(52) U.S. Cl. 99/450

(57) ABSTRACT

A multi-use rack includes first and second side edges and a downwardly extending front portion. The first and second side edges of the rack are adapted to slide along a top portion of at least two guide rails of an oven. The downwardly extending front portion of the rack is adapted to engage a front end portion of the at least two guide rails such that a stop is provided between the downwardly extending front portion and the front end portions of the guide rails.

### CROSS REFERENCE TO RELATED APPLICATIONS

This application claims the benefit of U.S. Provisional Patent Application No. 60/558,273, filed on Mar. 31, 2004, and entitled SUMP RACK.

### BACKGROUND OF THE INVENTION

1. Field of the Invention

The present invention relates to racks for appliances, and more particularly, to a multi-use rack for an oven.

2. Description of Prior Art

Ovens often have one or more racks generally within the oven. The racks are useful for the placing of cookware, food, and other items, within the oven. The racks place the cookware generally towards the middle of the oven, and keep the cookware away from heating elements and the like. In addition, ovens with multiple racks allow for placement of cookware on a variety of levels within the oven, thereby increasing the total volume of available cooking space.

The racks are often supported by ledges formed along the inner walls of the oven. The racks are then movable in and out of the oven on the ledges. This allows the racks to be removed from the oven for cleaning or for other purposes. Often, the racks may be partially removed from the oven so as to allow easier access to items placed on the racks. The ledges also facilitate vertical adjustment of the racks within the oven cavity.

Oven racks are often of wire form construction. More specifically, an outer wire frame and a support platform, which is constituted by a plurality of fore-to-aft and laterally spaced wires, define a typical oven rack. The wires are substantially evenly spaced across the entire rack for use in supporting food items to be cooked.

### BRIEF SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with an aspect of the present invention, a multi-use rack for an appliance is provided. The multi-use rack includes a rack of a substantially rectangular shape defined by first and second side edges and front and rear crossbars, wherein the first and second side edges are adapted to slide along a top portion of at least two guide rails in an appliance, and wherein the front crossbar of the rack extends downwardly and is adapted to engage a front end of at least one of the two guide rails.

In accordance with another aspect of the present invention, a multi-use rack in combination with an oven includes: an oven having at least two guide rails provided on opposing sidewalls thereof; and a rack having first and second side edges and a downwardly extending front portion; wherein the first and second side edges of the rack are adapted to slide along a top portion of the at least two guide rails, and wherein the downwardly extending front portion of the rack is adapted to engage a front end portion of the at least two guide rails such that a stop is provided between the downwardly extending front portion and the front end portions of the guide rails.

In accordance with yet another aspect of the present invention, a multi-use rack is provided, which includes: a rack having a substantially rectangular configuration; wherein the rack consists of two downwardly extending projections, one of the downwardly extending projections being located at a front right corner portion of the rack, and the other of the downwardly extending projections being located at a front left corner portion of the rack.

In accordance with yet another aspect of the present invention, a method of positioning an oven rack on a guide rail in an oven is provided, which includes: sliding an oven rack along two bottom guide rails, positioned on opposing sidewalls in an oven, such that first and second side edges of the oven rack slidably engage top portions of each of the bottom guide rails until a front portion of the oven rack engages a front end of at least one of the bottom guide rails to stop the oven rack from sliding further.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 illustrates a perspective view of an example of a multi-use rack in accordance with an aspect of the present invention;

FIG. 2 illustrates a partial view of the multi-use rack of FIG. 1 in an oven environment in accordance with an aspect of the present invention;

FIG. 3 illustrates a perspective view of another example of a multi-use rack in accordance with an aspect of the present invention;

FIG. 4 illustrates a partial view of the multi-use rack of FIG. 3 in an oven environment in accordance with an aspect of the present invention; and

FIG. 5 illustrates a partial view of a prior art oven rack in an oven environment.

### DESCRIPTION OF EXAMPLE EMBODIMENTS

The present invention relates to a multi-use rack for an oven. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention may be practiced without these specific details.

Referring initially to FIG. 5, a partial view of a conventional oven rack 10 is depicted in an oven environment 20. The conventional oven rack 10 comprises a wire frame and is shown employed in a standard rack location 30 in the oven environment 20. The standard rack location 30 includes a top guide rail 40 and a bottom guide rail 50. The top guide rail 40 includes a downward-facing projection 60 and the bottom guide rail 60 includes a corresponding groove portion 70. The oven rack 10 includes an upward-facing portion 80 integrally formed in the wire frame of the oven rack 10 to facilitate alignment of the oven rack 10 within the oven. Specifically, the upward-facing portion 80 is adapted to contact the downward-facing projection 60 of the top guide rail 40 such that a stop is created to properly align the oven rack 10 with respect to the top and bottom guide rails 40, 50.

However, in a sump position of the oven 20, only a bottom guide rail 90 is provided. Thus, because there is no corresponding top guide rail with a downward-facing projection, the oven rack 10 would have to be carefully positioned on bottom guide rail 90 if a user wanted to use the conventional rack 10 in the sump position, as there is no stop to correspond with the upward-facing projection 80 of the oven rack 10.

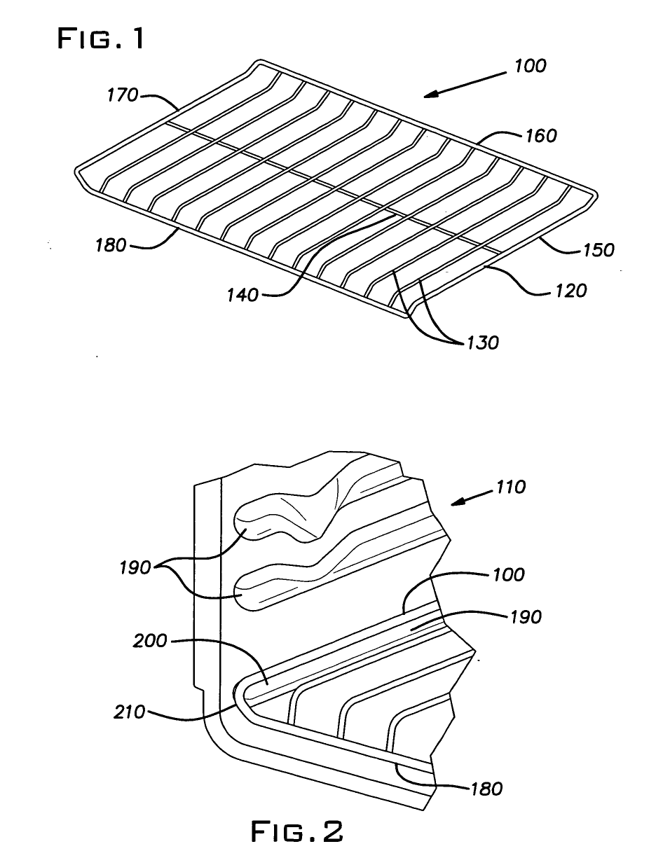

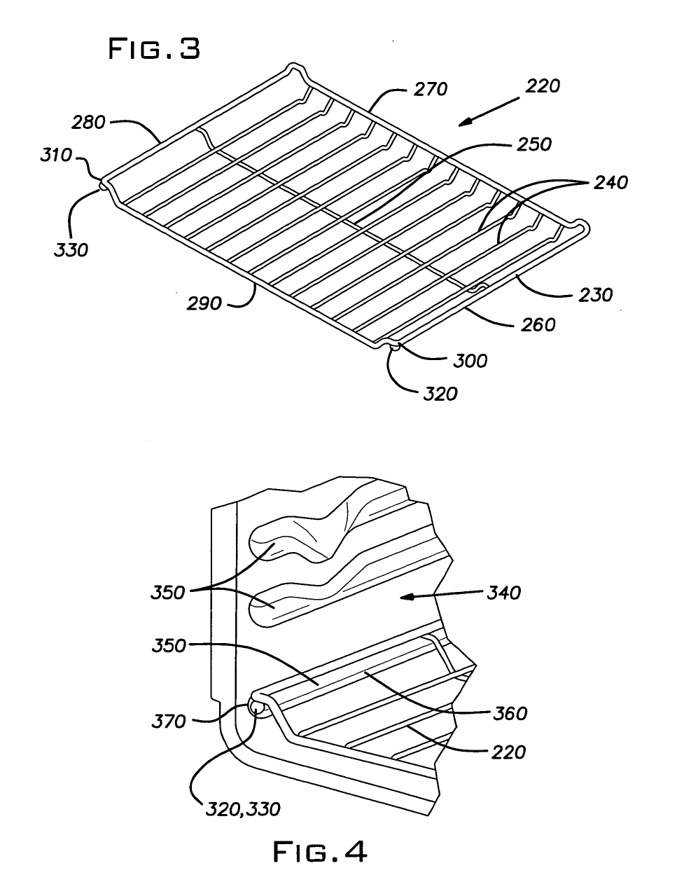

Turning now to FIGS. 1 and 2, an example of a multi-use rack 100 for an oven is illustrated in accordance with an aspect of the present invention. The multi-use rack 100 can be utilized in a sump position of an oven environment 110 and in any other rack position in the oven 110. A frame 120, a plurality of bars 130, and one or more optional cross-members 140 define the multi-use rack 100. The frame 120, bars 130, and cross-member(s) 140 can be manufactured from steel or any other suitable material which provides adequate strength to support items such as cake pans, pizza stones and casseroles and withstands the heat of an oven. The multi-use rack 100 can be formed by bending a continuous frame wire into a shape to form a first side edge 150, a rear crossbar 160, a second side edge 170, and a front crossbar 180. The plurality of bars 130 are also formed from wire and each have a first end welded or otherwise secured to the rear crossbar 160 and a second end welded or otherwise secured to the front crossbar 180. Likewise, the cross-member(s) 140 is formed of wire and has a first end welded or otherwise secured to the first side edge 150 and a second end welded or otherwise secured to the second side edge 170. The cross-member(s) 140 acts to increase the strength of the multi-use rack 100. The wires can be coated with a glass material, such as porcelain, to protect the multi-use rack 100 from discoloration and the like due to heating of the wire at high temperatures.

So that the multi-use rack 100 can be utilized in any rack position in an oven, including the sump position, the multi-use rack 100 includes a downwardly extending portion at a front section of the multi-use rack 100 to form a stop. For instance, the downwardly extending portion of the multi-use rack 100 of FIGS. 1 and 2 comprises the front crossbar 180, which is formed such that it projects downwards with respect to a generally horizontal plane formed by a central portion of the multi-use rack 100. Corresponding ends of the first and second side edges 150, 170 and bars 130 can also be formed to extend downwards from the generally horizontal plane of the multi-use rack 100 to form a smooth transition between the generally horizontal plane of the multi-use rack 100 and the downwardly extending front crossbar 180. The front crossbar 180 can extend downwardly at an angle of approximately ninety degrees respect to the first and second side edges. Alternatively, the front crossbar 180 can extend downwardly at an angle between about forty-five degrees and about ninety degrees with respect to the first and second side edges. However, it is to be appreciated that the front portion of the multi-use rack 100 can be bent at any suitable angle to form a stop with a bottom guide rail of an oven.

FIG. 2 further illustrates how the downwardly extending front crossbar 180 of the multi-use oven rack 100 forms a stop within the oven environment 110. As is conventional, the oven 110 includes a plurality of guide rails 190 projecting from a sidewall thereof. However, in the conventional oven configuration, a bottommost guide rail 200 provided in the sump position does not include a corresponding top guide rail having a downwardly extending projection, as in the other rack positions. Accordingly, the downwardly extending front crossbar 180 of the multi-use rack 100 forms a stop with the bottommost guide rail 200, thereby facilitating quick and easy placement of the rack 100 within the oven. A user is able to slide the multi-use rack 100 onto the bottommost guide rail 200 such that the first and second side edges 150, 160 of the rack 100 slide along a top portion of the guide rail 200 until the front crossbar 180 contacts an end portion 210 of the guide rail 200; thereby properly and securely positioning the multi-use rack 100 along the guide rail 200. Although not illustrated, it is recognized that the downwardly extending front crossbar 180 can be employed in any of the other rack positions in the oven 110 in a similar manner. Specifically, the design of the multi-use rack 100 allows the user to position the rack 100 on the standard rack position and slide the rack 100 along a bottom guide rail until the downwardly extending front crossbar 180 contacts an end portion of the bottom guide rail.

Additionally, the downwardly extending front crossbar 180 can act as a handle for the multi-use oven rack by creating a lip or edge to grab when removing the rack 100 from the oven.

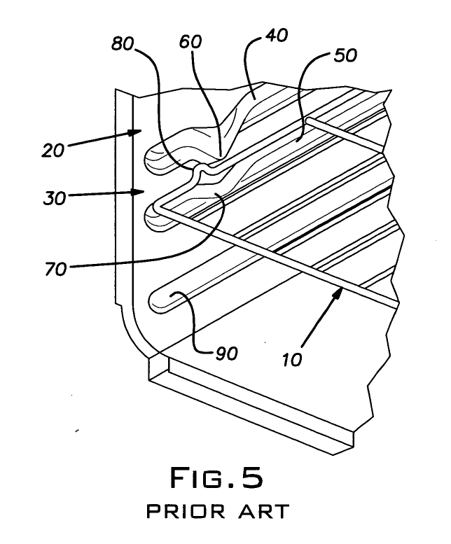

Turning now to FIGS. 3 and 4, another example of a multi-use rack 220 for use in an oven is illustrated in accordance with an aspect of the present invention. The multi-use rack 220 can be manufactured from steel wire or the like and includes a substantially rectangular shaped frame 230 supporting a plurality of bars 240 and one or more optional cross-members 250. The frame 230 can be formed by bending a continuous wire into the substantially rectangular shape to form a first side edge 260, a rear crossbar 270, a second side edge 280, and a front crossbar 290. The plurality of bars 240 are also formed from wire and each have a first end welded or otherwise secured to the rear crossbar 270 and a second end welded or otherwise secured to the front crossbar 290. Likewise, the cross-member(s) 250 is formed of wire and has a first end welded or otherwise secured to the first side edge 260 and a second end welded or otherwise secured to the second side edge 280. The cross-member(s) 250 acts to increase the strength of the multi-use rack 220. The wires can be coated with a glass material, such as porcelain, to protect the multi-use rack 100 from discoloration and the like due to heating of the wire at high temperatures.

The first and second side edges 260, 280 project upwardly and outwardly from a generally horizontal plane formed by the multi-use rack 220. The intersections between the first and second side edges 260, 280 and the front crossbar 290 form front right corner 300 and front left corner 310. At least one, and preferably both, of the front right and left corners 300, 310 include a projection extending downwardly therefrom. For instance, in the illustrated embodiment, two ball-shaped projections 320, 330 are welded or otherwise secured to a bottom portion of the front right and left corners 300, 310, respectively. The ball-shaped projections 320, 330 provide a stop for the multi-use rack 220 when slid along a bottom guide rail of an oven. It is to be appreciated that any projection of any suitable size and shape that extends downwardly from one or both of the front right corner 300 and the front left corner 310 can be employed. Further, the downwardly extending projection(s) can be positioned at any suitable location on the multi-use rack such that the downwardly extending projection(s) are operable to form a stop with one or more bottom guide rails of the oven. The projection(s) can be permanently welded or otherwise secured to the multi-use rack 220. Alternatively, the downwardly extending projection(s) can be removably secured to the multi-use rack 220. It is to be further appreciated that the downwardly extending projection(s) can be made of any suitable material, such as metal, plastic, and the like, such that the projection(s) can withstand the operating heat of the oven.

FIG. 4 further illustrates how the downwardly extending projection(s) of the multi-use oven rack 220 forms a stop within an oven environment 340. As is conventional, the oven 340 includes a plurality of guide rails 350 projecting from a sidewall thereof. However, in the conventional oven configuration, a bottommost guide rail 360 provided in the sump position does not include a corresponding top guide rail having a downwardly extending projection, as in the other rack positions. Accordingly, the downwardly extending projection(s) 320, 330 of the multi-use rack 220 forms a stop with the bottommost guide rail 360, thereby facilitating quick and easy placement of the rack 220 within the oven 360. A user is able to slide the multi-use rack 220 onto the bottommost guide rail 360 such that the first and second side edges 260, 280 slide along a top portion of the guide rail 360 until the projection(s) 320, 330 contacts an end portion 370 of the guide rail 360; thereby properly and securely positioning the multi-use rack 220 along the guide rail 360. Although not illustrated, it is recognized that the downwardly extending projection(s) 320, 330 can be employed in any of the other rack positions in the oven 340 in a similar manner. Specifically, the design of the multi-use rack 220 allows the user to position the rack 220 on the standard rack position and slide the rack 220 along a bottom guide rail until the downwardly extending projection(s) 320, 330 contacts an end portion of the bottom guide rail.

It is to be appreciated that the racks of the subject invention can be used in settings other than in an oven. For example, the racks of the subject invention could be used in a refrigerator and/or freezer unit. Further, it is to be appreciated that the racks can be constructed of any suitable material, such as metal, plastic, and the like. Further still, the frame, the bars, and the cross-member(s) need not be constructed from the same materials.

It is to be further appreciated that the size and shape of the multi-use racks described herein can also depend upon an intended use of the rack. In the exemplified embodiments, the racks are sized to slide into or replace a rack of a conventional domestic oven. Likewise, the bars are spaced to accommodate cookware. However, the frame of the rack can be made larger to fit commercial ovens or sized to fit any apparatus in which the racks are to be used. The bars of the rack can be spaced appropriately within the frame to hold any designated item.

The invention has been described hereinabove using specific examples; however, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

1. A multi-use rack for an appliance comprising:
a rack of a substantially rectangular shape defined by first and second side edges and front and rear crossbars, wherein the first and second side edges are adapted to slide along a top portion of at least two guide rails in an appliance, wherein the front crossbar of the rack extends downwardly and is adapted to engage a front end of at least one of the two guide rails.

2. The multi-use rack of claim 1, wherein the rack comprises a wire frame having a plurality of wire bars extending between the front and rear crossbars.

3. The multi-use rack of claim 2, wherein the rack further comprises one or more wire cross-members extending between the first and second side edges.

4. The multi-use rack of claim 1, wherein the plurality of wire bars each have a first end portion and a second end portion, and wherein the first end portions of the wire bars extend downwardly to engage the front crossbar.

5. The multi-use rack of claim 1, wherein the front crossbar extends downwardly at an angle of approximately ninety degrees with respect to the first and second side edges.

6. The multi-use rack of claim 1, wherein the front crossbar extends downwardly at an angle between about forty-five degrees and about ninety degrees with respect to the first and second side edges.

7. The multi-use rack of claim 1 being a rack for an oven.

8. A multi-use rack and oven combination comprising:
an oven having at least two guide rails provided on opposing sidewalls thereof; and
a rack having first and second side edges and a downwardly extending front portion;
wherein the first and second side edges of the rack are adapted to slide along a top portion of the at least two guide rails, and
wherein the downwardly extending front portion of the rack is adapted to engage a front end portion of the at least two guide rails such that a stop is provided between the downwardly extending front portion and the front end portions of the guide rails.

9. The multi-use rack of claim 8, wherein the downwardly extending front portion comprises and front crossbar of the rack.

10. The multi-use rack of claim 8, wherein the downwardly extending front portion comprises at least one projection extending from a front corner of the rack and is adapted to engage one of the front end portions of the guide rails.

11. The multi-use rack of claim 10, wherein the at least one projection comprises first and second ball-shaped projections, wherein the first ball-shaped projection extends from a front right corner of the rack and the second ball-shaped projection extends from a front left corner of the rack.

12. A multi-use rack for an appliance, comprising:
a rack having a substantially rectangular configuration; wherein the rack consists of two downwardly extending projections, one of the downwardly extending projections being located at a front right corner portion of the rack, and the other of the downwardly extending projections being located at a front left corner portion of the rack.

13. The multi-use rack of claim 12, wherein the two downwardly extending projections are welded to the rack.

14. A method of positioning an oven rack on a guide rail in an oven comprising:
sliding an oven rack along two bottom guide rails, positioned on opposing sidewalls in an oven, such that first and second side edges of the oven rack slidably engage top portions of each of the bottom guide rails until a front portion of the oven rack engages a front end of at least one of the bottom guide rails to stop the oven rack from sliding further.
